(19) United States
(12) Patent Application Publication
(10) Pub. No.: US 2010/0323636 A1
(43) Pub. Date: Dec. 23, 2010

(54) Apparatus and methods for implementing multi-channel tuners

(76) Inventors: Nicholas Cowley, Wroughton (GB); Isaac Ali, Bristol (GB); Terry Steeper, Lincoln (GB); Alan J. Martin, Plymouth (GB); Damian Gruszka, Lincoln (GB); Andrew Johnson, Lincoln (GB)

Correspondence Address: INTEL CORPORATION;c/o CPA Global, P.O. BOX 52050, MINNEAPOLIS, MN, 55402, US

(21) Appl. No.: 12/456,930

(22) Filed: Jun. 23, 2009

(51) Int. Cl. H04B 1/40

(52) U.S. Cl. 455/77

(57) ABSTRACT

Embodiments of systems and methods for implementing multi-channel tuners are generally described herein. Other embodiments may be described and claimed.

### TECHNICAL FIELD

The present disclosure relates generally to the field of wireless communications and more particularly to methods and related systems for mitigating multi-channel interaction in multi-tuner devices.

### BACKGROUND

Electronics devices for consumers and businesses include increasingly more diverse functionalities. Among the functions being provided in various electronic systems such as computer systems and set top boxes is the reception of television signals or similar multimedia streams over one or more channels. A mobile computing platform, such as a laptop computer, mobile internet device, station and client may include a video receiver capable of receiving one or more multimedia signals in the same platform. This type of implementation in a platform may vary greatly depending on the specific transmission specification, which may be dependent on the geographic region or other factors.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 (Prior Art) is a graph illustrating effects of multi-channel pulling;

FIG. 2 is a block diagram of an electronic system in accordance with some embodiments of the invention;

FIG. 3 is a block diagram of the electronic system in accordance with some embodiments of the invention;

FIG. 4 is a block diagram of the electronic system accordance with some embodiments of the invention;

FIG. 5 is a graph illustrating application of local oscillator prescaling in accordance with some embodiments of the invention; and

FIG. 6 is a flowchart that describes an embodiment of a method for mitigating multi-tuner interaction.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details for mitigating multi-channel interaction in multi-tuner platforms are set forth to provide a thorough understanding of the invention. However, it will be understood by those skilled in the art that the present invention may be practiced without these specific details. In other instances, well-known methods, procedures, components and circuits have not been described in detail so as not to obscure the present invention.

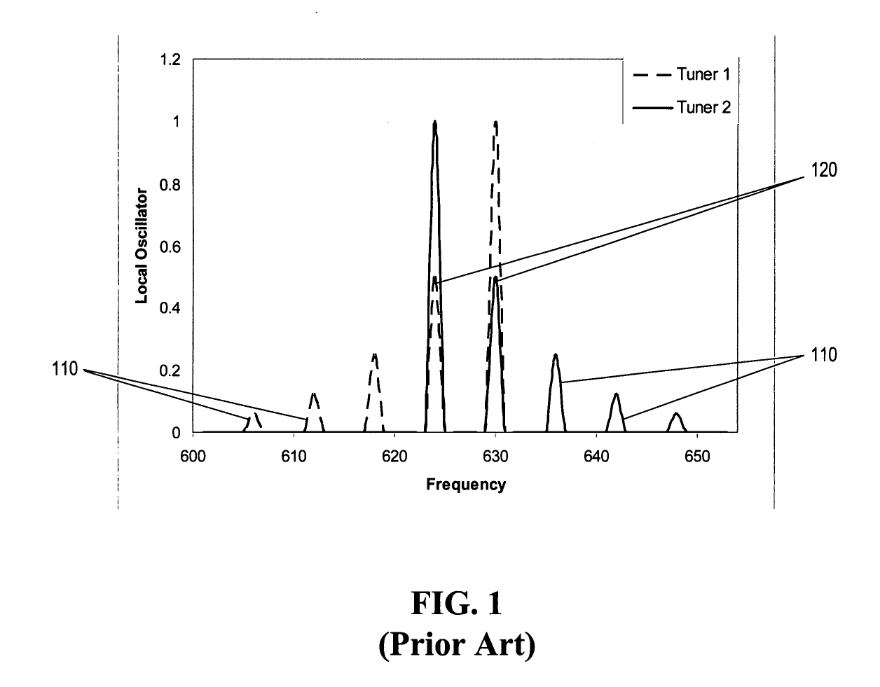

It would be an advance in the art to provide an apparatus and methods for implementing a plurality of tuners, wherein the tuners can be independently tuned to any and all channels from a commonly received spectrum and wherein all or part of the tuning components are disposed on a common substrate in the same electronic system while avoiding intra-system interaction that can negatively affect performance. Performance of electronic devices with tuners capable of receiving two or more channels in a common spectrum can degrade when the channels are tuned close to or equal to the same harmonically related frequencies, resulting in impairment of the service. Typically, it is found that in such circumstances that local oscillators associated with each channel or tuner can injection lock or “pull” each other, generating multiple sidebands 110 and interference 120 in desired channels as shown in FIG. 1 (Prior Art), degrading channel quality.

Applications requiring more than one tuner in the same system are typically implemented so each tuner is independently isolated through application of electromagnetic coupling isolation. Application of the electromagnetic coupling isolation requires additional space and expense which is a burden, particularly in mobile devices designed with small form factors for low cost applications. It would be useful to employ a system and methods to avoid interaction between the channels or instances where interaction may occur as opposed to reducing the effects of injection lock or “pulling.” Mitigation of multi-tuner interaction would be especially important in instances where all or part of the components of the tuners are located on a monolithic integrated circuit or disposed on a common substrate.

Some embodiments of the invention may be used in conjunction with various devices and systems, for example, a Personal Computer (PC), a set-top box, a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11g, 802.11n, 802.16, 802.16d, 802.16e standards and/or future versions and/or derivatives and/or Long Term Evolution (LTE) of the above standards, units and/or devices which are part of the above networks, one way and/or two-way radio communication systems, cellular radiotelephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

Some embodiments of the invention may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), Global Positioning System (GPS), Wi-Fi, Wi-Max, ZigBee (TM), Ultra-Wideband (UWB), Global System for Mobile communication (GSM), 2G, 2.5G, 3G, 3.5G, or the like. Embodiments of the invention may be used in various other devices, systems and/or networks.

The terms “interference” or “noise” as used herein include, for example, random or non-random disturbances, patterned or non-patterned disturbances, unwanted signal characteristics, Inter Symbol Interference (ISI), electric noise, electric interference, white noise, non-white noise, signal distortions, shot noise, thermal noise, flicker noise, “pink” noise, burst noise, avalanche noise, noise or interference produced by components internal to a device attempting to receive a signal, noise or interference produced by co-existing components of a device attempting to receive a signal, noise or interference produced by components or units external to a device attempting to receive a signal, random noise, pseudo-random noise, non-random noise, patterned or non-patterned interference, or the like.

The term “mitigation” (e.g., of interference or noise) as used herein includes, for example, reduction, decrease, lessening, elimination, removal and/or avoidance.

The terms “television signal(s)” or “digital television signals” as used herein include, for example, signals carrying television information, signals carrying audio/video information, Digital Television (DTV) signals, digital broadcast signals, Digital Terrestrial Television (DTTV) signals, signals in accordance with one or more Advanced Television Systems Committee (ATSC) standards, Vestigial SideBand (VSB) digital television signals (e.g., 8-VSB signals), Coded ODFM (COFDM) television signals, Digital Video Broadcasting-Terrestrial (DVB-T) signals, DVB-T2 signals, Integrated Services Digital Broadcasting (ISDB) signals, digital television signals carrying MPEG-2 audio/video, digital television signals carrying MPEG-4 audio/video or H.264 audio/video or MPEG-4 part 10 audio/video or MPEG-4 Advanced Video Coding (AVC) audio/video, Digital Multimedia Broadcasting (DMB) signals, DMB-Handheld (DMB-H) signals, High Definition Television (HDTV) signals, progressive scan digital television signals (e.g., 720p), interlaced digital televisions signals (e.g., 10180i), television signals transferred or received through a satellite or a dish, television signals transferred or received through the atmosphere or through cables, signals that include (in whole or in part) non-television data (e.g., radio and/or data services) in addition to or instead of digital television data, or the like.

Among the television signals that may be utilized for video is the recent China digital television standard. The standard is designated number GB20600-2006 of the SAC (Standardization Administration of China), and is entitled “Framing Structure, Channel Coding and Modulation for Digital Television Terrestrial Broadcasting System”, issued Aug. 18, 2006. The standard may also be referred to as DMB-T (Digital Multimedia Broadcasting-Terrestrial) or DMB-T/H (Digital Multimedia Broadcasting Terrestrial/Handheld). This standard will generally be referred to herein as “DMB-T”.

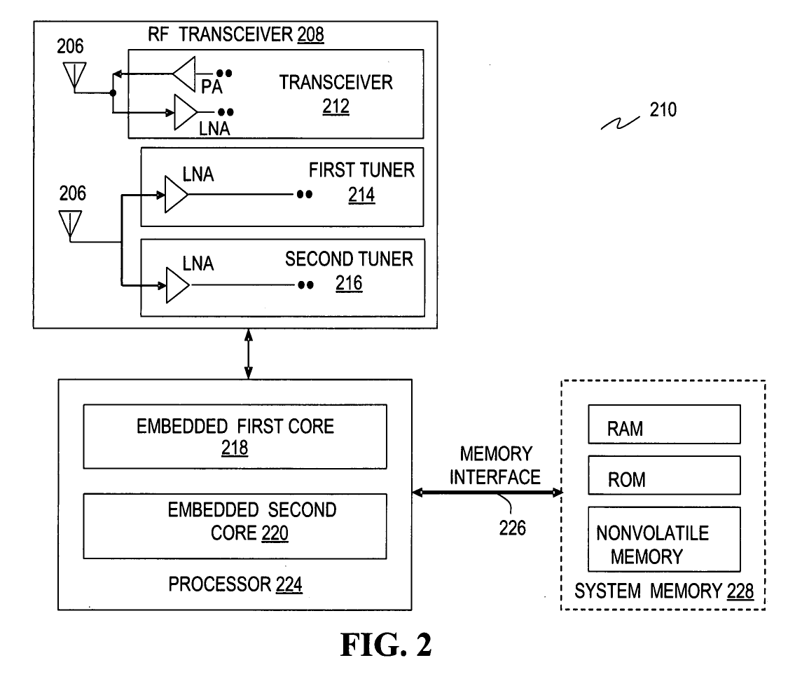

FIG. 2 illustrates an electronic system 210 that includes multiple radios to allow communication with other over-the-air communication devices according to some embodiments of the invention. In another embodiment of the invention (not shown), a the electronic system 210 is a wired communications system configured to allow communication with two or more wired and/or wireless communication devices. The electronic system 210 may operate in a number of systems such as, for example, Digital Video Broadcasting-Handheld (DVB-H) that brings broadcast services to handheld receivers as adopted in the ETSI standard EN 302 304; Digital Multimedia Broadcasting (DMB); Digital Video Broadcasting-Terrestrial (DVB-T); the Integrated Services Digital Broadcasting-Terrestrial (ISDB-T) in Japan; or Wireless Fidelity (Wi-Fi) that provides the underlying technology of Wireless Local Area Network (WLAN) based on the IEEE 802.11n specifications, although the present invention is not limited to operate in only these networks. Thus, the radio subsystems co-located in electronic system 210 provide the capability of communicating in an RF/location space with other devices in a network.

The simplistic embodiment illustrates an RF transceiver 208 with one or more antenna(s) 206 that may receive host transmissions such as WWAN, WiFi, etc., that are coupled to a transceiver 212 to accommodate modulation/demodulation. The antennas 206 also receive transmission for a first tuner 214 and a second tuner 216 to receive “data bits” used to make a TV picture and sound in the Digital television (DTV) broadcasting technology from a commonly received spectrum. The commonly received spectrum may be the same spectra, for example a terrestrial television transmission or independent spectra sharing common frequencies, for example terrestrial television transmissions and cable television transmissions.

Each antenna 206 may comprise one or more directional or omnidirectional antennas, including, for example, dipole antennas, monopole antennas, patch antennas, loop antennas, microstrip antennas, or other types of antennas suitable for transmission of radio frequency (RF) signals. In some embodiments, instead of two or more antennas, a single antenna with multiple apertures may be used. In these embodiments, each aperture may be considered a separate antenna. In some multiple-input, multiple-output (MIMO) embodiments, the RF transceiver 208 may use two or more of antennas that may be effectively separated to take advantage of spatial diversity and the different channel characteristics that may result between each of the antennas 206 and one or more host transmission source(s) transmitting a transport stream.

Appropriate to a received MPEG-2 transport streams and the different technical constraints of the received data, a demodulation scheme may be selected to provide the demodulated signals to a processor 224. By way of example, the receiver may include OFDM blocks with pilot signals and the digital demodulation schemes may employ QPSK, DQPSK, 16 QAM and 64 QAM, among other schemes. The analog transceiver 212, first tuner 214, and the second tuner 216 may be embedded with a processor 224 as a mixed-mode integrated circuit where baseband and applications processing functions may be handled by processor cores 218 and 220.

The processor 224 may transfer data through a memory interface 226 to memory storage in a system memory 228 comprising one or more of a volatile and/or nonvolatile memory for storage. For example, nonvolatile memory may include one or more of the following: read-only memory (ROM), programmable ROM (PROM), erasable PROM (EPROM), electrically EPROM (EEPROM), a disk drive or solid state drive (e.g., 228), a floppy disk, a compact disk ROM (CD-ROM), a digital versatile disk (DVD), flash memory, a magneto-optical disk, or other types of nonvolatile machine-readable media capable of storing electronic data including instructions. The processor 224 as illustrated in this embodiment provides two core processors or central processing unit(s). The processor 224 may further be any type of processor such as a general purpose processor, a network processor (which may process data communicated over a computer network), etc. (including a reduced instruction set computer (RISC) processor, an application specific integrated circuit (ASIC), or a complex instruction set computer (CISC)). In alternate embodiments, the processor 224 may have a single or quad core design. The processor 224 with a multiple core design may integrate different types of processor cores on the same integrated circuit (IC) die. Also, the processor 224 with a multiple core design may be implemented as symmetrical or asymmetrical multiprocessors.

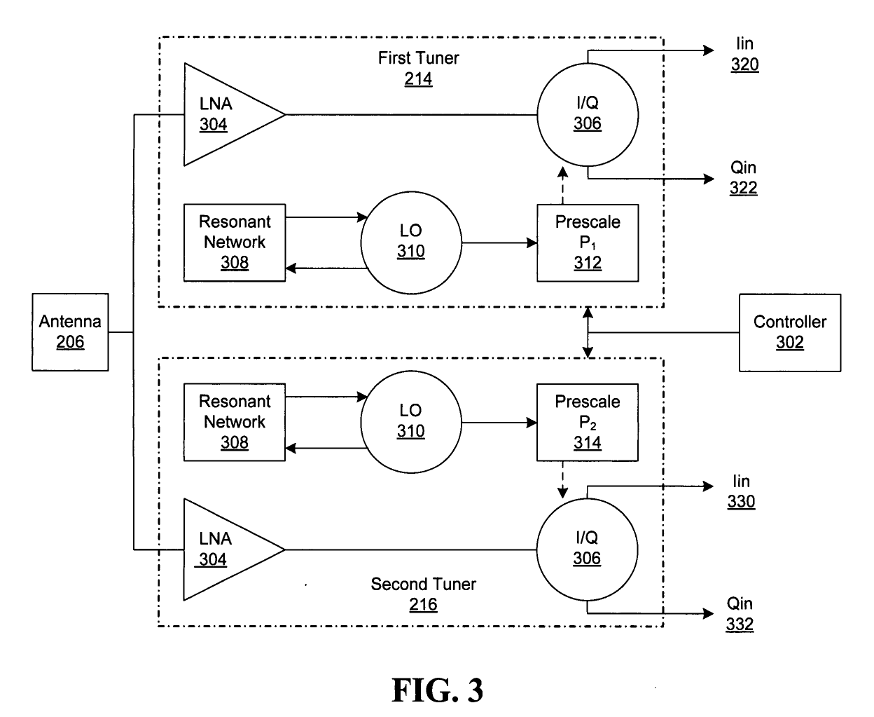

FIG. 3 is a block diagram of the electronic system 210 in accordance with some embodiments of the invention. Here, the antenna 206 coupled to the first tuner 214 and the second tuner 216 of FIG. 2 is connected to a controller 302 to mitigate interaction between the tuners. Two tuners 214, 216 are illustrated in FIG. 3, though more tuners may be added. The controller 302 may be the processor 224 of FIG. 2 or a separate controller in the form of a general purpose processor, a network processor (which may process data communicated over a computer network), etc. (including a reduced instruction set computer (RISC) processor, an application specific integrated circuit (ASIC), or a complex instruction set computer (CISC)).

The first tuner 214 and the second tuner 216 each comprise a low noise amplifier (LNA) 304 that is used to amplify signals captured by the antenna 206. A resonant network 308 coupled to a local oscillator 310, wherein the local oscillator 310 with a sustaining amplifier (not shown) provide a high quality factor (Q) amplifier, or an amplifier with a distance between an upper and lower frequency points that is very narrow, centered on a resonant frequency. Additional local oscillators 310 and prescalers such as the prescale P₁ 312 may be added per tuner (not shown) to satisfy design considerations.

As described earlier, when the resonant network 308 of a first tuner 214 is placed in proximity to a second tuner 216 that is tuned to the same or close to the same frequency as the first tuner 214, any energy close to the resonant frequency that couples into a resonator of the resonant network 308 at or close to the resonant frequency will be amplified within a loop of the resonant network 308. The coupled energy from interaction between the first tuner 214 and the second tuner 216 may lead to a spectrum as illustrated in FIG. 1 (Prior Art).

To overcome interaction between tuners 214, 216, a first prescale component 312 with available prescaling values is connected to the local oscillator 310 is provided in the first tuner 214 and a second prescale component 314 with available prescaling values is connected to the local oscillator 310 is provided in the second tuner 216. The local oscillator 310 having an absolute tuning range consistent with operating characteristics of the local oscillator 310 is operated at a multiple of a required commutating frequency by a ratio P, which is programmable to two or more ratios not related by a ratio of 2^{N}. Each ratio may further be multiplied by 2^{N}. The first tuner 214 and the second tuner 216 are coupled to the controller 302 which is configured to program the ratio P and to program a required tuning frequency. A mixer stage I/Q 306 is provided to receive and combine a RF signal from the LNA 304 with a frequency signal from the LO 310 to provide an in-phase (Iᵢₙ) 320 signal and a Quadrature signal (Qᵢₙ) 322 for downstream components. The tuners 214 and 216 are capable of independent tuning to any frequency within a common frequency range and converting the desired channel to an output intermediate frequency, where the frequency may be the same and constant for each tuner. The output frequency of each mixer 306 may desirably be, but not limited to quadrature (in-phase and quadrature) components centered around 0 Hz (i.e. a direct conversion or ZIF receiver).

In this embodiment, the first tuner 214 and the second tuner 216 each comprise a prescale 312, 314 component, however the embodiment is not so limited. As an alternative, the first tuner 214 may comprise prescale 312 to accommodate the second tuner 216 without a prescaling component (not shown). In an embodiment, the first tuner 214 is tuned to a channel at F₁ megahertz (MHz) and the prescale P₁ 312 ratio is set to P₁. The local oscillator 310 frequency is set at F₁×P₁. The second tuner 216 may be tuned to receive a channel at F₂ MHz with a prescale P₂ 314 ratio set to P₂. If F₁ and F₂ are close and prescale P₁ 312 is equal to or nearly equal to prescale P₂ 314, the local oscillators 310 may begin to interact and cause ‘pulling’, as shown in FIG. 1 (prior art). However, the controller 302 can predict this interaction and adjust the prescale P₂ 314 ratio when the second tuner 216 is tuned to F₂ so that the local oscillator 310 frequencies no longer lie close together, or at a harmonic of each other, since pulling may also occur when oscillators are harmonically related. The adjustment of the prescale P₂ 314 ratio can also be applied to adjust the second tuner 216 to avoid pulling when the second tuner 216 is tuned to receive the same or nearly the same channel as the first tuner 214, or when the commutating frequencies of each tuner 214, 216 are the same.

As an example, the first tuner 214 is tuned to a channel where F₁=600 MHz and the prescale P₁ 312 ratio is set to 4, resulting in a local oscillator 310 at 2400 MHz in the first tuner 214. The second tuner 216 may then be tuned to receive a channel where F₂=603 MHz. If the prescale P₂ 314 ratio is equal to 4, then pulling may otherwise occur. However, the controller 302 may predict interaction between the local oscillators 310 and adjust the prescale P₂ 314 ratio so that it is equal to 5, resulting in the local oscillator 310 of the second tuner 216 being set to 3015 MHz to avoid possibility of ‘pulling.’ To continue with the example, if the first tuner 214 is then set to 750 MHz with the prescale P₁ 312 ratio set to 4, the local oscillator 310 of the first tuner 214 will be 3000 MHz, then ‘pulling’ may again occur. The controller 302 can predict this interaction and adjust the prescale P₁ 312 ratio to be set to 5 to set the local oscillator 310 of the first tuner 214 to 3750 MHz to avoid possibility of ‘pulling.’ If however, the first tuner 214 is tuned to receive a channel at 750 MHz with the prescale P₁ 312 ratio set to 4, the local oscillator 310 of the first tuner 214 will be 3000 MHz and the second tuner 216 is tuned to receive a channel at 603 MHz with the prescale P₂ 314 ratio at 4, the local oscillator 310 of the second tuner 216 will be at 2412 MHz, so no adjustment of P2 will be required to avoid ‘pulling.’ As shown by these examples, a prescaling is dependent on a tuning sequence and to avoid all possibilities of pulling, non-harmonically related prescaling ratios should be provided for each desired received channel. Further, prediction of ‘pulling’ and determination of prescaling ratios such as prescale P₁ 312 and prescale P₂ 314 may be dynamically determined by calculation when performing tuning, based on prior knowledge of the local oscillator frequency of other tuners, such as the first tuner 214 and the second tuner 216.

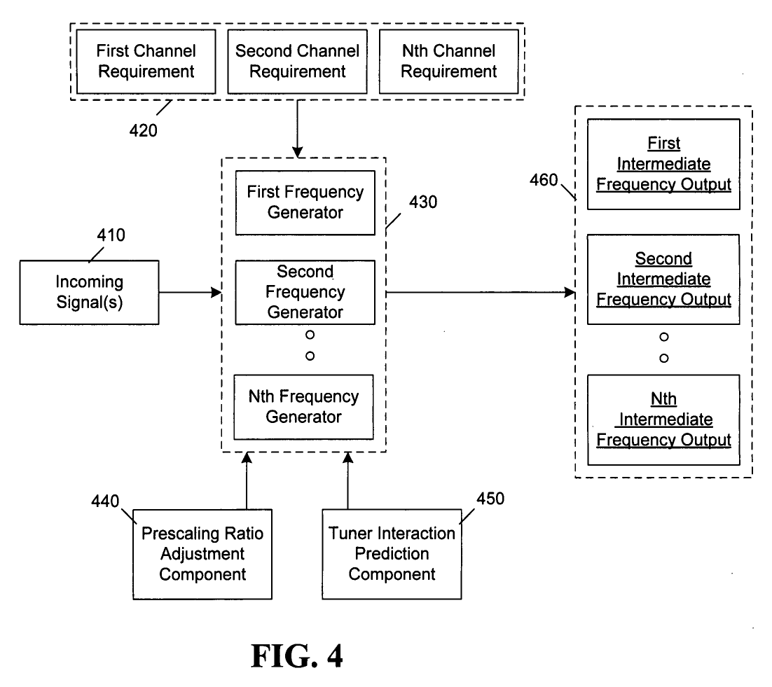

FIG. 4 is a block diagram of the electronic system 210 in accordance with some embodiments of the invention. An incoming signal 410 is received by one or more antennas 206 in the form of an RF signal to provide TV picture and sound in the Digital television (DTV) broadcasting technology from a commonly received spectrum. The electronic system 210 is configured with multiple tuners such as the first tuner 214 and the second tuner 216 of FIG. 2 and receives one or more channel requirements 420 from one or more sources such as a user, a programmed source such as a digital video recorder (DVR), a networked source, or another source. A plurality of frequency generators 430 for the plurality of tuners (e.g. first tuner 214 & second tuner 216), each comprising an amplifier 304, mixer 306, resonant network 308, and local oscillator 310. Outputs of each of the plurality of frequency generators 430 are modified by a prescaling ratio adjustment component 440 (e.g. prescale 312, 314) which may be a logic block or software subroutine, and a tuner interaction prediction component 450 which may be embodied in hardware and/or software form. For example, the tuner interaction prediction component 450 could be a software subroutine processed on the controller 302 of FIG. 3. Outputs from the frequency generators 430 are provided in the form of intermediate frequency outputs 460 to accommodate the channel requirements 420.

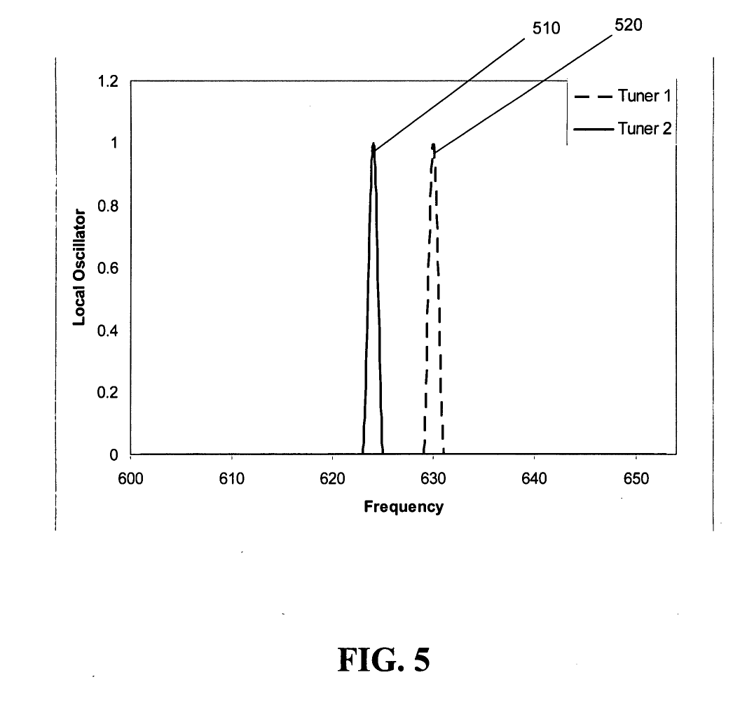

FIG. 5 is a graph of the commutating frequency input to mixer 306 illustrating application of local oscillator prescaling in accordance with some embodiments of the invention. Two peaks are illustrated, representing a first resonant frequency peak 510 of a first commutating frequency and a second resonant frequency peak 520 of a second commutating frequency lacking the sidebands 110 and the interference 120 of legacy systems, previously illustrated in FIG. 1 (Prior Art).

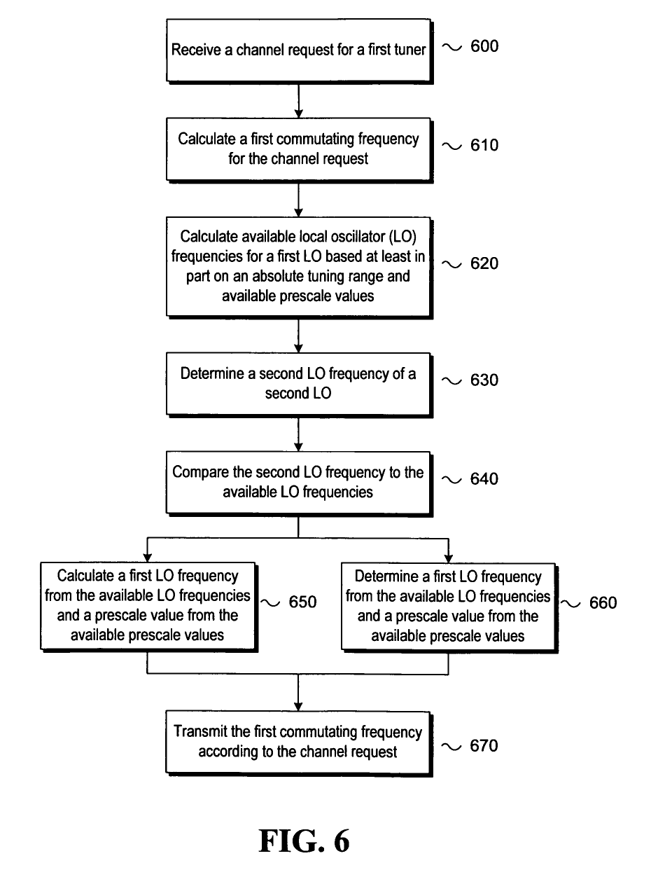

FIG. 6 is a flowchart that describes an embodiment of a method for mitigating multi-tuner interaction. In element 600, a channel request is received for a first tuner. In element 610, a first commutating frequency is calculated, based at least in part, on the channel request. In element 620, available local oscillator frequencies are calculated based at least in part on an absolute LO tuning range and available P values, where the Frequency of the first LO=P*Commutating frequency. In element 630, a second local oscillator frequency from a second local oscillator is determined. In element 640, the calculated frequency of the first local oscillator is compared against the frequency of the second local oscillator. In element 650, a calculated frequency for the first local oscillator that is offset from the frequency, a harmonic, or sub-harmonic of the frequency for the second local oscillator is selected along with a corresponding prescale value. Alternately in element 660, a look-up table is employed to determine a first LO frequency from available LO frequencies and a prescale value from available prescale values. In element 670, the first commutating frequency for the requested channel is transmitted according to the prescale value and the selected calculated frequency.

Embodiments may be described herein with reference to data such as instructions, functions, procedures, data structures, application programs, configuration settings, etc. For purposes of this disclosure, the term “program” covers a broad range of software components and constructs, including applications, drivers, processes, routines, methods, modules, and subprograms. The term “program” can be used to refer to a complete compilation unit (i.e., a set of instructions that can be compiled independently), a collection of compilation units, or a portion of a compilation unit. Thus, the term “program” may be used to refer to any collection of instructions which, when executed by the electronic system 210, performs multi-channel tuner capability without tuner to tuner interaction. The programs in the electronic system 210 may be considered components of a software environment.

The operation discussed herein may be generally facilitated via execution of appropriate firmware or software embodied as code instructions on the host processor 224 of the electronic system 210, as applicable. Thus, embodiments of the invention may include sets of instructions executed on some form of processing core or otherwise implemented or realized upon or within a machine-readable medium. A machine-readable medium includes any mechanism for storing or transmitting information in a form readable by a machine (e.g., a computer). For example, a machine-readable medium can include an article of manufacture such as a read only memory (ROM); a random access memory (RAM); a magnetic disk storage media; an optical storage media; and a flash memory device, etc. In addition, a machine-readable medium may include propagated signals such as electrical, optical, acoustical or other form of propagated signals (e.g., carrier waves, infrared signals, digital signals, etc.).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method for mitigating multi-tuner interaction, comprising:
receiving a channel request for a first tuner;
calculating a first commutating frequency associated with the channel request;
calculating available local oscillator (LO) frequencies for a first LO based at least in part on absolute tuning range and available prescale values;
determining a second LO frequency of a second LO;
comparing the second LO frequency to the available LO frequencies for the first LO;
calculating a first LO frequency and a first prescale value based at least in part on the second LO frequency; and
transmitting the first commutating frequency.

2. The method of claim 1, wherein the first LO frequency is set at a multiple of the first commutating frequency.

3. The method of claim 2, wherein the second LO frequency is N and the first prescale value is programmable to two or more ratios not related by a ratio of 2^{N}.

4. The method of claim 1, wherein the first LO frequency is not a harmonic frequency or a sub-harmonic frequency of the second LO frequency.

5. The method of claim 4, wherein a difference between the first LO frequency, or a harmonic or subharmonic thereof and the second LO frequency, or a harmonic or subharmonic thereof is maximized.

6. The method of claim 1, further including predicting if the first LO frequency is harmonically-related to the second LO frequency.

7. The method of claim 6, further including calculating a second LO frequency and a second prescale value based at least in part on the first LO frequency to provide a second commutating frequency.

8. A method of transmitting a commutating frequency according to a channel request in a multi-tuner environment, comprising receiving a request for a first commutating frequency, determining a range of local oscillator frequencies of a first LO and a range of available prescale values associated with the first LO, determining a second LO frequency of a second LO and determining a first LO frequency and a first prescale value, wherein the commutating frequency is based at least in part on the first LO frequency and the first prescale value.

9. The method of claim 8, wherein the first LO frequency is not a harmonic frequency or a sub-harmonic frequency of the second LO frequency.

10. The method of claim 9, wherein a difference between the first LO frequency, or a harmonic or subharmonic thereof and the second LO frequency, or a harmonic or subharmonic thereof is maximized.

11. The method of claim 8, wherein the first LO frequency is set at a multiple of the first commutating frequency.

12. The method of claim 8, wherein the second LO frequency is N and the first prescale value is programmable to two or more ratios not related by a ratio of 2^{N}.

13. The method of claim 8, further including predicting if the first LO frequency is harmonically-related to the second LO frequency.

14. The method of claim 13 further including calculating a second LO frequency and a second prescale value based at least in part on the first LO frequency to provide a second commutating frequency.

15. A multi-tuner system for providing a plurality of commutating frequencies, comprising
a first tuner to generate a first commutating frequency, the first tuner comprising a first local oscillator (LO) to provide a first LO frequency;
a second tuner to generate a second commutating frequency, the second tuner comprising a second LO to provide a second LO frequency and a prescaler to scale the second LO frequency, wherein the second LO frequency is offset from a haromonic or sub-harmonic of the first LO frequency; and
a controller to determine the second LO frequency and to scale the second LO frequency to provide the second commutating frequency.

16. The multi-tuner system of claim 15, wherein the prescaler is a logic block to divide the second LO frequency by a prescale ratio to provide the second commutating frequency.

17. The multi-tuner system of claim 15, wherein the multi-tuner system is a monolithic integrated circuit.

18. The multi-tuner system of claim 15, wherein each commutating frequency of the plurality of commutating frequencies is formed using at least two prescale values and two local oscillator frequencies.

19. The multi-tuner system of claim 18, wherein the first resonant network and a first amplifier of the first LO oscillator form a first high Q amplifier, and the second resonant network and a second amplifier of the second LO oscillator form a second high Q amplifier.

20. The multi-tuner system of claim 15, wherein the controller is configured to predict if the first LO frequency is harmonically-related to the second LO frequency.
